(19) United States
(12) Patent Application Publication
(10) Pub. No.: US 2009/0144814 A1
(43) Pub. Date: Jun. 4, 2009

(54) Automated Credentialing for Physicians and Other Professionals

(76) Inventor: John S. Sacco, Fayetteville, NY (US)

Correspondence Address: Bernhard P. Molldrem, Jr., 224 Harrison Street, Syracuse, NY, 13202, US

(21) Appl. No.: 11/949,073

(22) Filed: Dec. 3, 2007

(51) Int. Cl. H04L 9/32

(52) U.S. Cl. 726/6

(57) ABSTRACT

An automated system for credentialing physicians or practitioners in other professions employs a databank of verified practitioner data on a central computer server. The file for each practitioner can include education, employment history, board certification record, and derogatory information, such as disciplinary proceedings, if any. A remote computer station can access the central computer server to download a credentialing profile on the computer screen. The computer station can have an RFID reader for inputting a practitioner identity code that uniquely identifies the respective practitioner. There may be RFID tags embedded in diplomas or certificates to aid in verifying authenticity.

### BACKGROUND OF THE INVENTION

This invention relates to a technique for verifying credentials for each of a multiplicity of professional practitioners, e.g., physicians, surgeons, and other medical practitioners, or for other professionals such as architects, engineers, and lawyers where their practice affects the public safety or public trust. The invention is more specifically concerned with a technique for verifying the authenticity of a credentialing document presented by a practitioner to a credentialing committee, where the credentialing document(s) of each of the practitioners are maintained in a centrally maintained credentialing database, and in which other important background information relevant to a credentialing procedure is also maintained in the credentialing database.

The invention is more particularly concerned with a technique and system that makes it possible to verify the validity of the practitioner's credentials, and to do so on-line in real time or near real time.

The system of credentialing that is currently in use is tedious, paper intensive, and subject to delays and errors. Credentialing at hospitals and clinics is usually carried out by mail, telephone, or fax, requesting specific information about the practitioner from other hospitals, medical centers and groups, or clinics where the physician, surgeon, or other practitioner has been employed in the past. The credentialing offices, both at the hospital or clinic where the practitioner is applying for privileges, and at the places where the practitioner has previously practiced, might typically assign the credentialing work to the least experienced employees and assign the work the lowest priority.

Also, the practitioner typically presents certificates and diplomas as part of the credentialing process, and these may be inspected, but it is difficult to tell a genuine certificate from a forgery, and so it is usual to request confirmation from each school and each certifying board or agency. This is also done by mail, telephone, and fax and the process creates the opportunity for further delays and errors.

Because of fears of lawsuits for defamation, even when the lawsuit may be baseless, hospitals and clinics where the practitioner has been employed previously are often reluctant to pass on any derogatory information, i.e., any information about disciplinary actions taken involving the practitioner, or information about any malpractice claims that may have existed.

In addition to the possibility that a practitioner may have forged a credentialing document, there have been many instances of valid, bona fide documents having been stolen from a practitioner and used by other persons to obtain clinic or hospital privileges. The use of stolen documents is often harder to police than outright forgeries, and can go undetected even for a carefully conducted credentialing process.

In previous times, the persons conducting the credentialing process at a hospital, clinic, or medical center could rely on the existence of a medical school degree as exhibited on a diploma, a state license certificate, and other similar forms of paper documentation in order to know that the practitioner was the person that he or she claimed to be, and that the person was qualified to practice. Today, the prevalence of forged documents and other records makes it easy for a person to lie his or her way into hospital practice privileges. Consequently a new solution is needed to make such forgeries ineffective.

### OBJECTS AND SUMMARY OF THE INVENTION

It is therefore an object of the present invention to improve the techniques used in verifying a practitioner's credentials and to increase the speed of the process and to reduce the chance for errors in comparison with techniques now employed.

A further object of this invention is to provide immediate, and accurate credentialing information from a central credentialing database.

A still further object of the present invention is to address the problems caused by forged or stolen credentialing documents.

Another object of the present invention is to avoid the problems caused by the reluctance of prior institutions to provide negative or derogatory information about a practitioner, where such information exists.

It is yet another object to facilitate the credentialing and acceptance of bona fide and competent practitioners who are applying for privileges at a hospital, clinic or similar institution.

According to an aspect of this invention, an on-line credentialing system is presented as a solution to the problems stated above. At least a part of the solution involves using a primary source identifier for verification. That is, each practitioner is given a unique identification, i.e., a unique ID number, or a fingerprint scan, or another way of uniquely identifying the practitioner. The credentialing institution takes that unique identifier, and runs it against a live database of credentialing data. The database, which is kept at a central computerized location, i.e., on a central computer server, contains authentic data for each of the numerous professionals who are licensed to practice in the area, e.g., licensed to practice medicine in a given state or province. The database matches the primary source with the practitioners's credentialing data, and this is returned in real time or very near real time to the computer console at the requesting institution. Then the credentialing committee or intake person will have the information about the practitioners, such as a photograph of the practitioner, or biometrics such as a fingerprint scan, a retinal scan, voice recognition, or a rapid DNA scan, while he or she is there in the office.

The central computer server returns a credentialing profile for the identified practitioner, which will include his or her educational history, employment history, state or other board certifications, and the photograph and/or a biometric identifier of the practitioner. In addition, the existence of any derogatory information will be displayed, so that the credentialing committee can be informed about any disciplinary issues, malpractice insurance claims, that have been reported. The name and contact information of the practitioner's malpractice insurance carrier may also be displayed so that they can be contacted. This information can be printed out as a formatted report for the credentials committee.

According to one aspect of the invention, an RFID tag or chip may be embedded in the physician's credentialing documents, i.e., on the medical school diplomas and state medical license, in a location where the device is not visible or apparent to a person viewing the document. Then, when the document is presented for inspection, the document can be scanned with an RFID reader, which scans and picks up the code that is embedded in that RFID tag. This goes to the computer that is coupled with the reader, where it is decoded and sent along to the central server. Then the server returns information about the document, if it is valid. A forged document will not provide the correct verification data. Of course, the same can be accomplished with an invisible bar code (e.g., phosphorescent or fluorescent ink) imprinted on the face of the document, which can be picked up with a suitable black-light bar code scanner.

This technique makes it possible for agents of the state medical certifying office to conduct surprise visits, and simply scan the documents present on the practitioner's office wall to verify the validity of the practitioner's claimed credentials.

For a better understanding of these and other objects of the present invention, reference will be made to the following detailed description of a preferred embodiment of the invention which is to be read in conjunction with the accompanying Drawing Figures.

### BRIEF DESCRIPTION OF THE DRAWING

FIG. 1 is a side elevational cross section of a credentialing document, showing an embedded RFID tag.

FIG. 2 is shows the same or another credentialing document.

FIG. 3 is a schematic view of an automated credentialing system according to an embodiment of the invention.

FIG. 4 shows a screen display of an embodiment of the invention, that is returned from the server and presented on a computer screen.

FIG. 5 is a chart for explaining the process of this invention.

### DETAILED DESCRIPTION OF THE PREFERRED EMBODIMENT

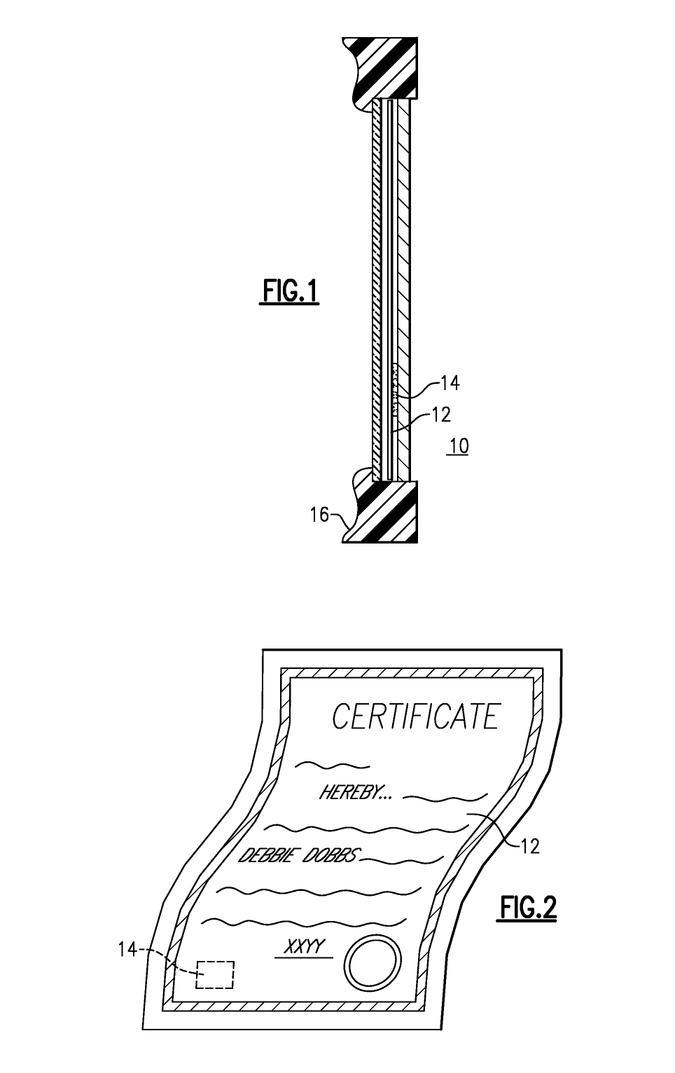

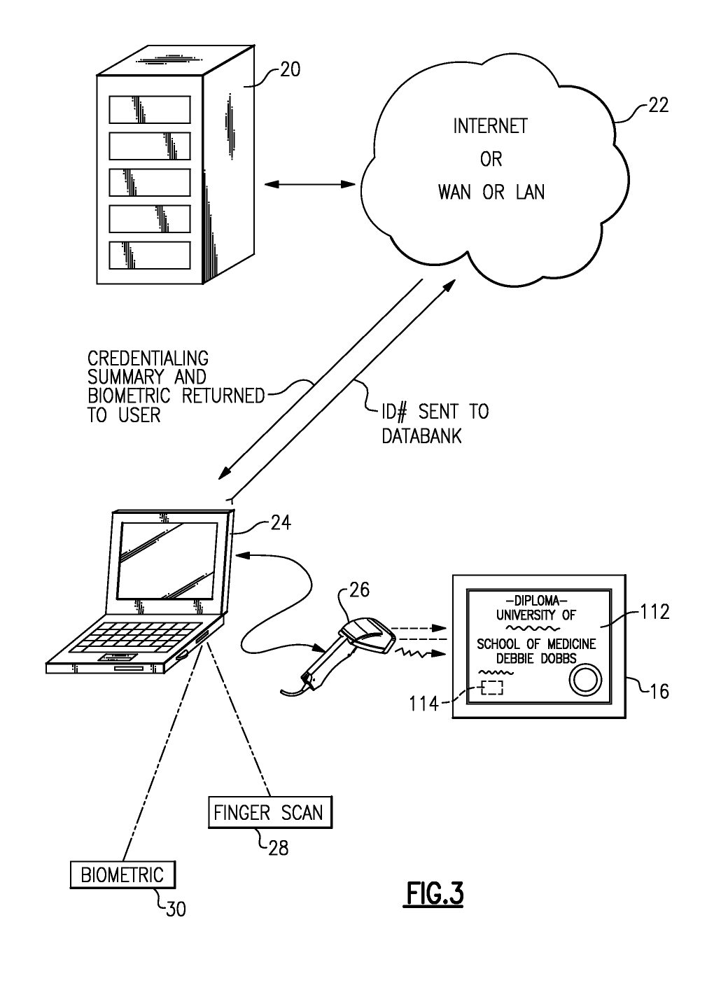

Referring now to the Drawing, and initially to FIGS. 1 and 2 thereof, a professional person's credentialing document 10, typically would be a certificate or diploma 12, and here is shown with an RFID tag 14 or an equivalent coded device embedded in the document. In this case, the RFID tag 14 is affixed onto the back or reverse side of the document, so that the tag 14 is not visible nor apparent while the document is in its frame 16. Typically, a document of this type is held in the frame 16 and mounted on the wall of the practitioner's office. The RFID tag 14 can be scanned while the document is in the frame 16.

FIG. 2 shows the certificate 12 itself, with the location of the RFID tag 14. Also on the certificate are an official seal, the name of the person awarded the certificate, the degree or certification awarded, and other data. The information that is stored and associated with the RFID tag must conform with what appears on the document, or the document will be identified as a suspected forgery or fabrication. Also, if the document is stolen from a bona fide practitioner to whom the certificate was actually awarded, the information that is obtained by scanning the RFID tag 14 may be used to expose the person presenting the credentials as a potential imposter.

One embodiment of the system for carrying out the automated credentialing process is shown in FIG. 3. Credentialing data from numerous practitioners within a given profession is stored on a central server computer 20. These credentialing data include school records, practice certification records, status of the practitioner at the licensing agency, and personal data such as age, sex, race, height and weight, and a photograph of the practitioner. The personal data facilitate verification of the person's identity during an interview.

These credentialing data are entered by the medical schools or other institutions, or by the certifying institutions or agencies who issue the credentialing data, or in some cases by the state medical licensing agency, and these are all stored securely on the server 20.

The server 20 is connected via the Internet 22, or via a wide area network or local area network, with a number of computer stations 24, i.e., one or more at each clinic or hospital where a practitioner is or may be applying for practice privileges. Only one such computer station 24 is shown here.

In this embodiment, an RFID scanner 26 is connected with the computer station 24, and is used for scanning a diploma 112 that has been presented by a candidate. The scanner 26 continuously interrogates until an embedded RFID tag 114 responds with a coded RF signal, containing a unique identification number. The RFID reader 26 then sends this identification number to the computer 24, which creates a formatted message and sends the RFID identification number back to the server 20. This identification number from the RFID tag 114 is received at the server 20, and the server then gathers the credentialing information that corresponds to that unique identification number, and responds by sending a credentialing summary back to the user computer station 24. The server has software that cooperates with the browser of the computer station 24 to present a credentialing profile on the screen of the computer. This profile information would include in most cases a photograph of the practitioner, validation of the license to practice, validated hospital affiliations, malpractice insurance carrier and coverage information, the educational or scholastic history of the practitioner, the employment history of the practitioner, and existence of any derogatory information, which may include malpractice claims, police record, or other appropriate items. Verification of the identification items that have been scanned can also be displayed.

In addition to the RFID scanner, there may be a finger scan device 28 for reading the person's fingerprint or thumbprint, or a biometric reader such as a retinal scanner, rapid-scan DNA device, or voice recognition intake device. Other items may be scanned in or keyed in to identify the practitioner, such as a driver's license or another standard, accepted form of identification.

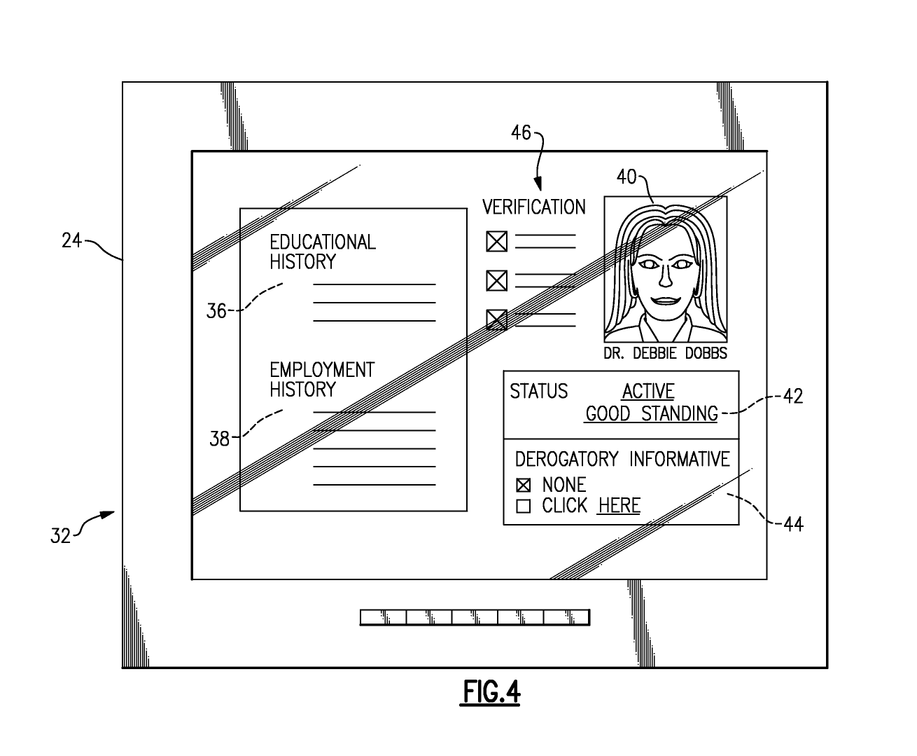

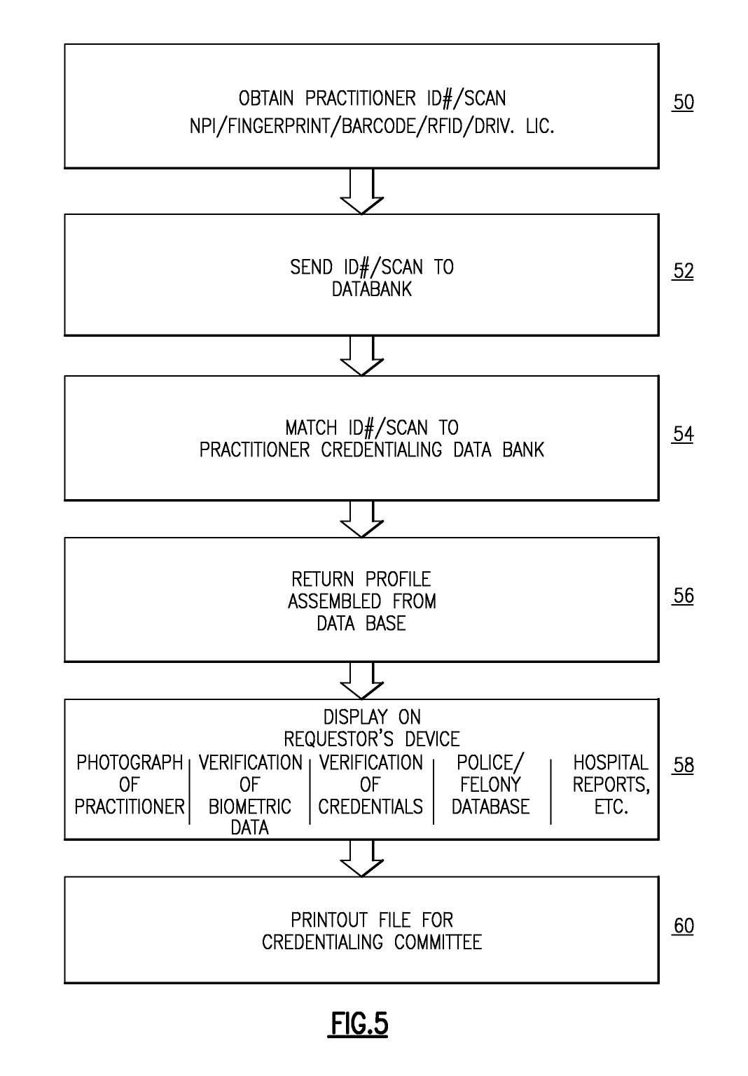

The credentialing profile may appear, e.g., as shown in FIG. 4, as a computer screen display 32 on the computer station 24, containing a formatted display of the credentialing profile that is returned from the central server 20. In this case, the display contains an educational history block 36 and employment history block 38 for the practitioner, and a photograph 40 of the practitioner. A display 42 of status of the practitioner, at the state licensing board or agency, for example, can show whether the practitioner is in good standing, or can reveal if there is some question about status that the credentialing committee needs to investigate. Below that is a display 44 that reveals the presence, if any, of derogatory information files. If such information exists, that can be made available on a subsequent screen (not shown here). This could include, for example, disciplinary action taken by a hospital or by the licensing agency, malpractice claims, criminal convictions, or the like. The collection of any such derogatory information at the central server, which would typically be operated at the state licensing agency, removes from the hospitals and clinics the risk of being sued for defamation just for mentioning that there was some question about a practitioner's practice history. The physician can also access and check the accuracy of the credentialing profile, via the computer and Internet, and contact the agency to correct any errors that may exist.

Also appearing here are verification blocks 46 to indicate that the status has been verified, for example of a certificate or diploma, i.e., that the credentialing document is authentic. These can also indicate the validity of a fingerprint scan, driver's license or other ID, or other identity or credential that is presented.

The process of automated verification and checking of practitioner's credentials can be explained with reference to the diagram of FIG. 5. In the credentialing process, the physician or other professional practitioner appears personally at the credentialing office of the hospital or clinic where he or she is applying for privileges. At that time the practitioner presents a number of diplomas, certifications, and or other documents, which may have embedded RFID tags, as described above. The practitioner may also present other forms of identification, such as a driver's license, and run his or her finger past the finger print scanner. The computer station then collects one or more unique practitioner identification numbers [block 50], and the computer processes the identification data and sends the identification code or number via Internet the server 20, where the server can access the appropriate information in its practitioner data bank [block 52]. The server matches the identification code to the practitioner, and then assembles the credentialing data for that practitioner into a profile or summary [block 54]. Then the server 20 returns to the requesting computer station 24 the credentialing profile that it has assembled from the practitioner database [block 56]. At this point, the computer station presents a video display, such as shown in FIG. 4, which can be used to verify the identity of the practitioner and also to display the credentialing information for the practitioner [block 58]. The display can show a photograph of the practitioner, verification of fingerprint scan, retinal scan, or other biometric data, if used, verification of the credentials presented by the practitioner, existence of police reports or felonies in the practitioner database, and reports from hospitals and clinics relevant to that practitioner.

The entire profile may be printed out [block 60] in sufficient copies for the hospital's credentialing committee. The printed profile may include additional information not on the summary screen or profile screen.

The system may also be used for spot inspections of clinics and hospitals, where the physicians will have their credentialing documents, i.e., certifications and diplomas, mounted and framed on their office walls. An agent for the state licensing agency may simply scan the documents, using a hand-held RFID scanner and a hand-held wireless computer device, to verify the authenticity of the diplomas and certificates by accessing the data base stored on the central computer. Forgeries and stolen documents will be discovered immediately, and the state can then step in and take action when needed.

The RFID tag may be applied on with a tamper-resistant or tamper-evident seal, or may in some cases be woven in or laser etched into the document itself, i.e., onto fibers woven into the paper or parchment.

While an RFID tag or chip 14 has been used in the embodiments discussed just above, there are other technologies that could be employed instead for embedding a unique identifying code on a document. For example, an invisible bar coded symbol could be printed on the document, using an ink that fluoresces only in certain special wavelengths, but would be detectable using a suitable bar code scanner. Also, a magnetic strip may be employed.

While this invention has been explained with reference to the particular structure disclosed herein, it is not confined to the details as set forth and this application is intended to cover any modifications and changes as may come within the scope of the following claims.

I claim:

1. System for credentialing professional practitioners comprising:
a central computer server containing a multiplicity of credential history files for a respective number of practitioners, each said file including educational records, employment history, board certification record, and file of derogatory information including a history of disciplinary proceedings, if any, for the respective practitioner;
a plurality of remote computer stations each at a location remote from the central computer server, and each said computer station having means for inputting a practitioner identity code that uniquely identifies the respective practitioner; means connecting over a network with said central computer server; and means for transmitting said practitioner identity code thereto;
said computer server having software adapted for accepting said practitioner identity code and transmitting back to the requesting remote computer station a practitioner credentialing profile which includes for the identified practitioner the respective employment history, educational history, board certification(s), and existence of any derogatory information for said practitioner.

2. Credentialing system according to claim 1, wherein each said remote computer station includes an RFID reader.

3. Credentialing system according to claim 1, wherein each said remote computer station includes a fingerprint scanner.

4. Credentialing system according to claim 1, wherein each said remote computer station includes a voice recognition device.

5. Credentialing system according to claim 1, wherein each said remote computer station includes a retinal scanner.

6. Credentialing system according to claim 1, wherein said remote computer station includes a biometric identification input device.

7. Credentialing system according to claim 1, wherein said server includes for each said practitioner a photograph of the practitioner, and said credentialing profile includes a photograph of the associated practitioner.

8. Credentialing system according to claim 1, wherein said credential history files include a history of malpractice insurance claims involving said practitioner.

9. Credentialing system according to claim 1, further comprising for each practitioner a set of one or more credentialing documents, and at least one of said credentialing documents including a detectable coded device that is hidden on said credentialing document and each said coded device carrying a unique code; and wherein each said remote computer station includes a reader device adapted to detect the unique code on said credentialing document.

10. Credentialing system according to claim 1, wherein each said detectable coded device includes an RFID tag embedded in said credentialing document.

11. Process for verifying credentials for each of a multiplicity of professional practitioners, each said practitioner having a credentialing history stored on a central server computer and including a unique identity code, educational history, employment history, board certification(s), history of disciplinary actions, if any, and a photograph of the practitioner; and wherein a plurality of remote computer stations are connected with the central computer server via a network; the process comprising the steps of
inputting one of said remote computers with the unique identity code for one of said practitioners;
transmitting the identity code to said central server computer;
the server computer responding by sending to said remote computer a credentialing file for the practitioner associated with said unique identity code, said credentialing file including for said practitioner at least a summary of the associated educational history, employment history, board certification(s), personal identification data, and disciplinary actions, if any; and
displaying on a video screen said credentialing file.

12. Process for verifying credentials according to claim 11, wherein said step of inputting one of said remote computers with a unique identity code includes scanning a credentialing document with a scanning device, wherein the credentialing document includes a hidden embedded coded device containing said unique identity code.

13. Process for verifying credentials according to claim 11, wherein said embedded coded device includes a hidden RFID tag; and said scanning device includes an RFID reader.

14. Process for verifying credentials according to claim 11, wherein said personal identification data includes biometric data unique to said practitioner.

15. Process for verifying credentials according to claim 11, wherein said personal identification data includes a photograph of said practitioner.
